(19) United States
(12) Patent Application Publication
(10) Pub. No.: US 2026/0037313 A1
(43) Pub. Date: Feb. 5, 2026

(54) BOUNDING RESOURCE CONSUMPTION IN SIGNAL WITH PENALTY BOX

(71) Applicant: CrowdStrike, Inc., Sunnyvale, CA (US)

(72) Inventors: Daniel Brown, Ipswich, MA (US); Jason Cherry, North Andover, MA (US)

(21) Appl. No.: 18/962,954

(22) Filed: Nov. 27, 2024

Related U.S. Application Data
(60) Provisional application No. 63/677,328, filed on Jul. 30, 2024.

(51) Int. Cl. G06F 9/50

(52) U.S. Cl. CPC G06F 9/5027

(57) ABSTRACT

The present disclosure provides techniques for selective removal of leaf nodes. A processing device tracks a count of leaf nodes associated with a parent node within a key space. The processing device identifies whether the count of the leaf nodes exceeds a threshold. The processing device removes the parent node within the key space in response to the count of leaf nodes exceeding the threshold. The processing device frees the resources utilized by the leaf node removed from the key space for use by other leaf nodes within the key space.

### CROSS-REFERENCE TO RELATED APPLICATIONS

This application claims priority to U.S. Provisional Patent Application No. 63/677,328, filed on Jul. 30, 2024, and entitled “BOUNDING RESOURCE CONSUMPTION IN SIGNAL WITH PENALTY BOX”, the entirety of which is incorporated herein by reference.

### TECHNICAL FIELD

Aspects of the present disclosure relate to selective removal of key spaces, and more particularly, to the selective removal of parent nodes within key spaces that exceed threshold resources.

### BACKGROUND

Stateful streaming processing is an application design pattern that includes continuous processing of streaming data while maintaining a database of past events. Streaming data or event streams are based on a configurable model of the stateful streaming processing application that defines portioning of an event domain. The model may partition data in a tree structure with one or more layers, where each layer represents a key space or domain in the model. The key space or domain may grow unbounded until available resources have been consumed. Selective removal of key spaces that have grown beyond a threshold may be performed to prevent inefficient use of resources.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system architecture in accordance with some aspects of the present disclosure.

FIG. 2 is a flow diagram of a method of for selective removal of leaf nodes within key spaces in accordance with some aspects of the present disclosure.

FIG. 3 is a block diagram that illustrates an example computing system for selective removal of leaf nodes within key spaces in accordance with some aspects of the present disclosure.

FIG. 4 is a block diagram that illustrates an example of a system for selective removal of leaf nodes within key spaces in accordance with some aspects of the present disclosure.

FIG. 5 illustrates a diagrammatic representation of a machine in an example form of a computer system that may perform one or more of the operations described herein in accordance with some aspects of the present disclosure.

### DETAILED DESCRIPTION

Stateful streaming processing operates over unbounded event streams based on a configurable model that defines how the event domain is partitioned for processing across a distributed cluster of compute nodes. The way the model partitions the data can be thought of as a tree structure with one or more layers. Each layer represents a key space or domain in the model and oftentimes the defined space or domain grows unbounded until all available resources have been consumed. A key space is a top level database object that controls the replication for the objects contained at each datacenter in a cluster. Removing resources by common eviction strategies fail since they often require removing data based on age or frequency of use. Furthermore, these strategies do not prevent the removed entries from re-entering the system again. At scale, the cost and complexity of continually adding resources to accommodate the unbounded key space growth is untenable.

Many solutions used for evicting or bounding resources do so based on age or frequency (high or low) and do not prevent removed events from re-entering the system. For example, a host that has been removed may reappear months or years later. Stateful streaming processing may rely on having a long history about the key space that has been configured so expiring or off-loading databases on typical solutions may move the problem to an external system that would itself grow unbounded. Furthermore, shuttling expired or evicted data between stateful streaming processing and an external system would introduce additional complexity and degrade performance.

The present disclosure addresses the above-noted and other deficiencies by using a processing device to selectively remove data based on usefulness to the system. The processing device tracks a count of leaf nodes associated with a parent node within a key space. The processing device removes the parent node within the key space in response to the count of the leaf nodes exceeding a threshold. The processing device frees the resources utilized by the leaf node removed from the key space for use by other leaf nodes within the key space. Embodiments may leverage such statistical model to automate the selective removal of data over unbounded data domains while retaining data that is contextually providing the most benefit to the system while reclaiming the resources from such portions of the key space.

In some embodiments, the processing device, to remove the parent node within the key space, selects the parent node for removal from the key space.

In some embodiments, the processing device places the parent node into a blacklist container, wherein subsequent events that arrive for processing by the leaf nodes associated with the parent node in the blacklist container are dropped.

In some embodiments, the processing device provides a broadcast message to remaining leaf nodes within the key space comprising instructions to reclaim resources dedicated to processing the leaf node in response to the removal of the parent node from the key space.

In some embodiments, the processing device, to remove the parent node within the key space, selects the parent node having a highest count of leaf nodes than other parent nodes within the key space.

In some embodiments, the parent node having the highest count of leaf nodes is selected for removal as having anomalous data that is inconsistent with historical or expected data.

In some embodiments, the parent node having the highest count of leaf nodes is selected for removal as being indicative of malicious behavior.

In some embodiments, the processing device, to remove the parent node within the key space, selects the parent node for removal that comprises data that is inconsistent with data of other parent nodes within the key space.

In some embodiments, the processing device, reinstates the parent node into the key space based on an exit policy.

In some embodiments, the exit policy is based on a time duration, a hyperloglog (HLL) algorithm, or a cardinality estimation.

As discussed herein, the present disclosure provides an approach that improves the operation of a computer system by selectively removing parent nodes within a key space that exceed threshold count. In addition, the present disclosure provides an improvement to the technological field of stateful streaming processing by selecting parent nodes for removal based on the value such leaf nodes are providing, as well as maintaining a near constant resource consumption over an unbounded event stream without the use of an external caching system.

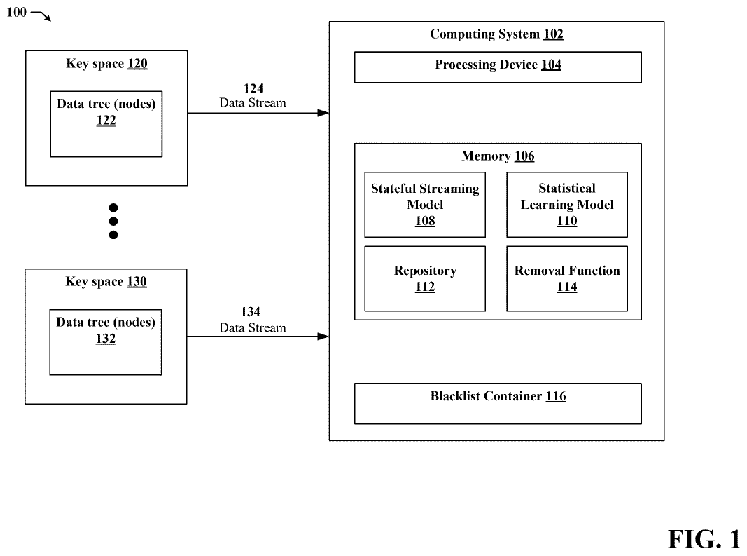

FIG. 1 is a block diagram 100 that illustrates an example of a system for selective removal of leaf nodes within key spaces in accordance with some aspects of the present disclosure. The system may include a computing system 102, a processing device 104, and a blacklist container 116. The memory 106 may include a stateful streaming model 108, a statistical learning model 110, a repository 112, and a removal function 114. The computing system 102 may receive multiple data streams (e.g., 124, 134) from multiple key spaces (e.g., 120, 130). The key spaces may each have a corresponding data tree structure (e.g., 122, 132), where each data tree is configured by the stateful streaming model and comprises one or more nodes and one or more leaf nodes.

In some aspects, the statistical model 110 tracks the number or count of nodes at each level within a tree that has been defined. A dedicated node is responsible for aggregating this information based on the key spaces defined within the stateful streaming processing model. Each key space and the number of child nodes it represents is sent to the processing node and stored in containers that have been configured based on the model. Each container represents a particular node size that an entry must meet before being admitted to the container. As nodes grow in size they are placed in the appropriate container. Once a configured threshold is reached, the processing node chooses an entry from the largest container and places this item in a blacklist container 116. For example, an entry having a high degree may be selected and placed in the blacklist container. The selected entry, selected by removal function 114, may include anomalous data that is inconsistent with historical or expected data. For example, the selected entry may indicate a high usage of resources that may be indicative of malicious behavior, or may be indicative of a large number of relationships of user(s) and the number of systems the user(s) that they are logged into. A feedback control loop is used to inform the portion of the pipeline that is responsible for ingest about the offending key space. This key space is then placed in state and subsequent events that arrive for processing are dropped and prevented from re-entering the system. In addition to being placed in the blacklist container, an additional message is broadcast to each node instructing each one to reclaim resources dedicated to processing the offending key space. The processing node will continue to periodically evaluate candidates for being placed within a corresponding blacklist container until the system has reduced resources below a configured threshold.

In some aspects, an internal node may be selected for placement in the blacklist container when a maximum leaf count threshold has been exceeded. In such instances, the degree of each internal node is known. Tracking the highest degree node explicitly may be costly, since at worst the sorted order of internal nodes can change on each event. The processing node may track a partial ordering of internal nodes to alleviate this cost and provide a good candidate for entry into the blacklist container, as opposed to a best candidate. In some instances, a good candidate may utilize less resources than a best candidate, but the data of the good candidate may not be useful for the system, such that placing the good candidate in the blacklist container is beneficial over a best candidate that is determined based on utilizing the highest amount of resources. In some instances, a configuration parameter may specify a set of bucket or container sizes, such as but not limited to [32, 64, 128, 256, 512, 1024, 2048, 4096, 8192, 16384, 32768]. When the degree of an internal node exceeds one of these thresholds, it and the associated parent node is placed in the corresponding bucket or container. For example, a customer identifier (CID) that adds its 32^{nd} leaf will be placed into the 32 bucket. If that CID should later be seen to add its 64th leaf, then it and the associated parent node will be removed from the 32 bucket and placed into the 64 bucket, etc. The largest configured bucket will hold internal nodes of that degree or higher. Each bucket might be implemented via a first in, first out (FIFO) operation. Use of the FIFO has the advantage of tending to select older nodes within each bucket with the likelihood that older candidates may tend to be higher degree than newer ones. The selection of the node to be placed in the blacklist container is then a matter of finding the highest order non-empty bucket and removing the oldest entry from the FIFO.

The placement of an item in the blacklist container comprises one or more of the following pieces of functionality: placing the interval variable (e.g., PatternId+CID) on an ingest blacklist, checking ingest items against the blacklist, checking leaf-to-internal items against the blacklist, or reclamation. For placement, the blacklist container will be checked periodically at ingest time. This checking is done against a fast data structure such as an O(1) map or hash table, where O(1) or Big O notation indicates that a running time of an algorithm is constant, regardless of input size. This data structure does not grow significantly since internal nodes represent a far smaller combinatoric space than leaf nodes. A FIFO of internal node values is maintained, so that penalized or blacklisted values can be retried (e.g., removed from the blacklist container) at a later time. For checking, ingest and leaf-to-internal events check the blacklist container. The latter check is performed because of the possibility of race conditions, where a leaf attempts to send a message to a just penalized or blacklisted internal node. For reclamation, after an internal node has been penalized, the resources associated with the tree can be reclaimed by removing associated leaves, while in some aspects, representation of the internal node is also removed.

The processing node utilizes a scoring system a scoring system is to identify events matching certain criteria that are unlikely to provide detection benefit and impose a high cost. In one embodiment, in the context of stateful streaming processing, which tracks and scores sets of variables with potentially high combinatorics, the processing node identifies lower-dimensioned variable value sets that should be preferentially pruned from the tree model due to low benefit and high memory cost. For example, in an indicator of attack (IOA) model, which has leaves indexed by {PatternId, CID, agent identifier (AID)}, consider a CID which has a large numbers of AIDs that emit the same pattern over time, a situation which will result in low scores while requiring many leaves. An AID is similar to a host machine. In this instance, the processing node should prune the subtree for a period of time, reclaiming the used memory and preventing matching elements from being scored or processed.

In stateful streaming processing, compute costs are controlled by early filtering of repetitions at a tree leaf. For example, in the IOA model, a report of a particular IOA pattern ID from a specific AID is throttled to no more than some rate like one event per minute. Events more frequent than this are suppressed. In stateful streaming processing the control of memory use may be referred to as pruning the tree, such that the contents are placed in the blacklist container, and not the bounding of compute cost via repetitive event suppression at the leaf.

In some aspects, the threshold for the blacklist container may be configurable. For example, the threshold for the blacklist container may be chosen to represent the least valuable data based on the cardinality and prevalence of the key space to the stateful streaming processing. If at some point in the future the statistical model may determine to re-introduce the key space and continue its processing. In such instances, the system will seed the restored key space with a relevant start time of when it is re-introduced to account for the time it spends in the blacklist container.

In some aspects, the overall memory cost of the tree can be measured by the number of nodes in the tree, but the number of nodes will be dominated by the number of leaves. For example, the maximum and expected number of CID nodes by pattern ID will be far outweighed by the maximum and expected number of AID nodes. As such, the cost of the tree will be measured in terms of the number of leaf nodes. The overall memory usage of the model tree may be expressed in terms of the number of leaf nodes.

In some aspects, the cost of an internal variable, that is, the variable one level above the leaf (CID in the S.IOA model) is measured, as in the case of overall cost tracking, may be based on the number of leaves under each internal node of the tree. The processing node may identify high degree interval variable nodes (CIDs with a large number of AID leaves) and preferentially blacklist those against lower degree examples.

In some aspects, the internal node may be removed from the blacklist container. Removal of the internal node from the blacklist container may be done periodically by selecting, for example, the oldest item from the FIFO and then removing that entry from a blacklist map as well. This will restore normal treatment of the variable for that variable combination.

In some aspects, items removed from the blacklist container may be returned to the blacklist container. In such instances, a more sophisticated blacklist container mechanism may be utilized that includes a list of FIFOs, where each are grouped by the next higher order variable (IOA in the case of S.IOA), and where selection is random, but weighted toward shorter FIFOs. The weight might be calculated by using the distribution of FIFO lengths, calculating the surprisal value for each FIFO (e.g., negative log probability), and choosing a random FIFO using this weighting. Smaller FIFOs may represent IOAs where high node degree is more surprising and are therefore more likely to represent an internal node that will return to a low degree regime following its stint in the blacklist container. Conversely, IOAs (e.g., higher order model variables) associated with long FIFOs are likely to represent high recidivist behavior.

Grouping has a logical intersection with the blacklist container. For example, consider a PatternId+CID internal node, where there might be some set of values in the node's new FIFO that represent AIDs where the pattern is noisy for an extended period of time. A group is formed when several new values are added to this FIFO in a short period of time. Grouping could be implemented as a form of blacklist container, where if the group is formed, new ingested values are first checked to see if they are members of the initial set of noisy AID values that are stored explicitly in the internal node, and if not, are considered members of the group. This allows the small set of initial noisy AID values to be maintained explicitly, but members of the group formation to be treated more simply and cheaply as the complement of the set of locally noisy AID values. This removes the ability to identify repetitious reports of group members but eliminates the need to use memory to track each group member explicitly once the group is formed.

Stateful streaming processing may be oriented around entities and relationships. For example, for a model that detects unusual logons for a user, distinct hosts are tracked for each user. So, space complexity can be viewed by the user, and some users require more space to track over time than others. Placing items in the blacklist container is a method for tracking this by-entity cardinality, and selectively removing from tracking the entities that require the most memory space to track. It may be desirable to take some entities out of the blacklist container.

In some aspects, various strategies can be used to predict which entities are most likely to be seen as low cardinality once removed from the blacklist container. Wrong guesses may end up being put back into the blacklist container. An example of a heuristic strategy is to use information about entities prior to their being in the blacklist container. For example, information about how long the entity existed prior to being put into the final high cardinality bucket. Entities which existed for longer prior to being put into the blacklist container can be prioritized for removal from the blacklist container by using a priority queue in the blacklist container.

In some aspects, a hyperloglog (HLL) algorithm may be utilized as a space efficient way to estimate cardinality. Rather than tracking entries in a distribution explicitly, HLL involves computing the hash of an entry that would go into the distribution, and counts entries that have similar prefixes, using the resulting bucketed distribution to estimate the overall distribution cardinality. An HLL sketch can be computed for each entity when placed in the blacklist container and setting a timer for each entity. After expiration of that timer, an entity can be considered for removal from the blacklist container. These entities can be arranged in a priority queue of buckets in the same way that the cardinality of non-blacklist container entities are tracked, bucketed and used for admittance into the blacklist container.

In some aspects, using HLL may include memory or information related to old data. Some entities might have HLL distributions that indicate large space requirements historically, but ground truth might be that over a more recent time period, its space requirements would be seen to be meager. In such instances, these types of entities would be identified and/or prioritized for removal from the blacklist container. In order to achieve a recent history bias, the HLL distribution may be degraded. The distribution may be utilized as a probability distribution, generating a random value according to the probability distribution, and decrement the count for the corresponding bucket. This can be done once the HLL has reached a point where it represents some number of previously input data values. For each new input data event, one value may be chosen from the distribution randomly but weighted according to the relative bucket sizes. Thus, the distribution will tend to be biased toward a shape that is representative of recent data values. If the distribution of recent values is the same as the distribution of old values, this random selection process for decrementing bucket counts will maintain the shape of the distribution. If the distribution of recent values is different than old values, then the distribution will tend to change shape in the direction of the distribution of recent values. As the HLL distribution changes to favor representation of the distribution of recent values, the cardinality estimate can more accurately select entities that are more likely to have smaller space requirements under the assumption that recent past is more predictive of future behavior than the distant past.

In some aspects, instead of tracking the number of inputs before degrading the HLL distribution, allow it to track a certain amount of time by keeping a fixed size FIFO queue of counts per unit time. For example, a count of values for each period of time (e.g., one hour) would allow for a degradation after a configured period of time (e.g., number of hours) has expired, degrading the bucket counts according to the oldest number of values. This may account for periods of time that influenced the HLL distribution (and consequently the cardinality estimate) the most, providing a more accurate estimate for recent periods with low event rates.

In some aspects, cardinality estimation may cause some entities never to leave the blacklist container. This may occur because large cardinality entities are the most expensive to keep and produce the least information gain upon seeing new values.

In some aspects, a number of different exit policies are possible. A simple exit policy comprises a selection of lowest cardinality estimated entity to be removed from the blacklist container once per hour or some other configurable rate. In some aspects, when putting an entity into the blacklist container, any number of entities may be removed until the total of their estimated cardinality reaches some value proportional to the cardinality of the entity that is being placed into the blacklist container. For example, if the cardinality of the entity being placed in the blacklist container is 1000, then we might free the two blacklisted entities whose cardinality estimate totals 500, if we configured the ratio to be 0.5.

In one embodiment, the use of the blacklist container allows the stateful streaming processing to operate on unbounded event streams over unbounded data domains in perpetuity while only retaining the data that is contextually providing the most benefit while reclaiming the resources from portions of the key space that do not justify the cost or provide much benefit. In one embodiment, the automatic selection of leaf nodes to remove based on the value they are providing to the system, the ability to prevent leaf nodes from being re-introduced and re-claiming valuable resources, where the reintroduction of those leaf nodes can be processed at a later date should they be deemed valuable again at a later date. In one embodiment, a near constant resource consumption is maintained over an unbounded event stream in near-real time without the use of an external caching system allowing stateful streaming processing to remain online indefinitely.

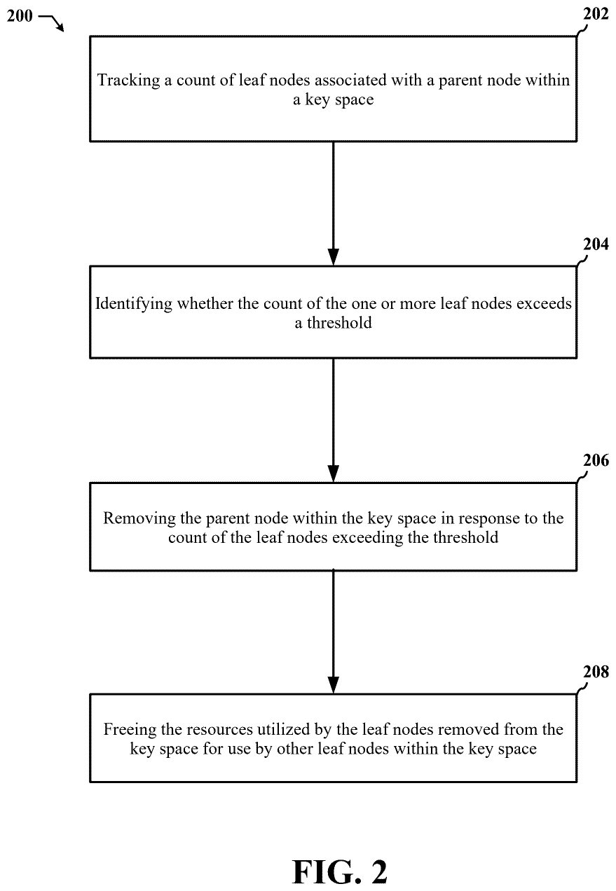

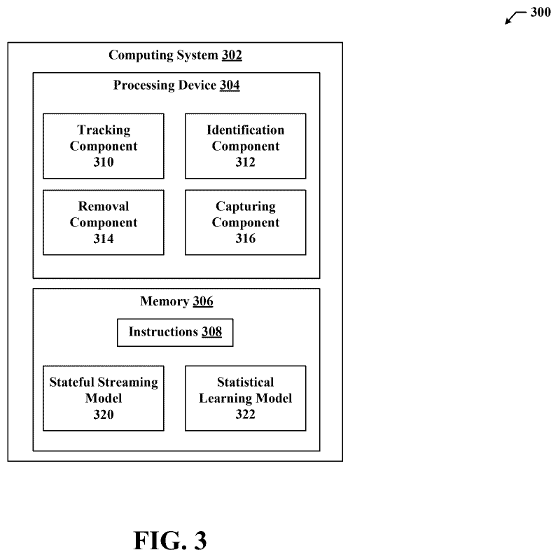

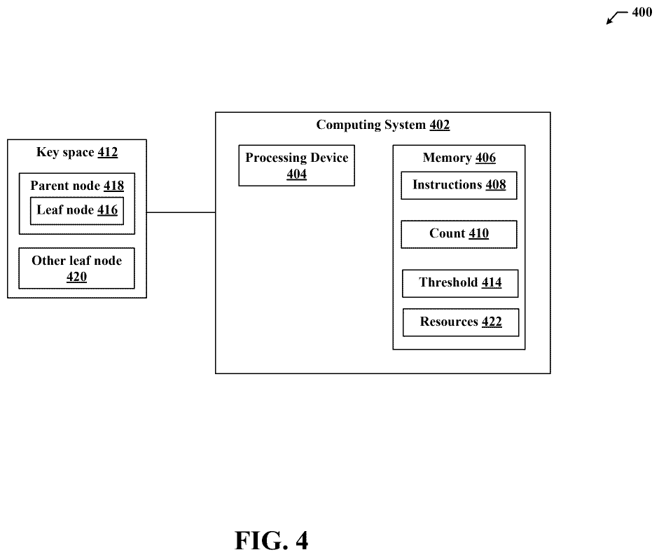

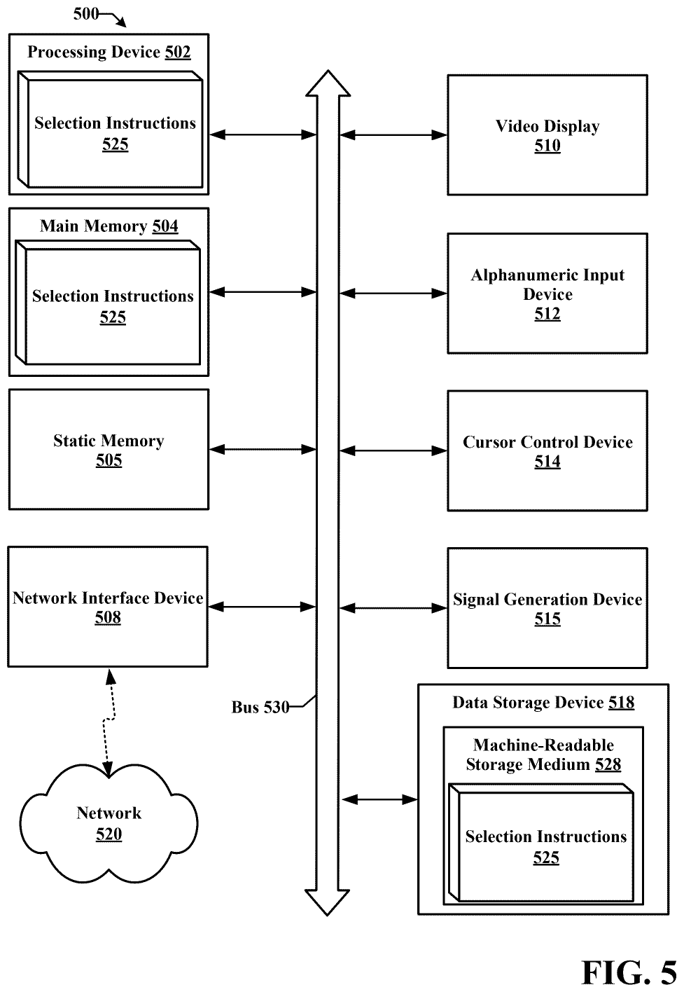

FIG. 2 is a flow diagram 200 of a method for selective removal of parent nodes within key spaces in accordance with some aspects of the present disclosure. The method of diagram 200 may be performed by processing logic that may include hardware (e.g., a processing device), software (e.g., instructions running/executing on a processing device), firmware (e.g., microcode), or a combination thereof. In some aspects, at least a portion of the method may be performed by processing device 104 (shown in FIG. 1), the processing device 304 (shown in FIG. 3), the processing device 404 (shown in FIG. 4), the processing device 502 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

With reference to FIG. 2, at block 202, processing logic may track a count of one or more leaf nodes associated with a parent node within a key space. The processing logic may track the number of nodes at each level within a tree. The leaf nodes are sent to the processing node and stored in containers, where each container represents a particular node size that an entry must meet before being admitted to the container.

At block 204, processing logic identifies whether the count of the one or more leaf nodes exceeds a threshold. For example, once a configured threshold is reached, the processing node chooses an entry from the largest container and places this item in a blacklist container. The processing logic tracks the count of leaf nodes per parent node, but the determination of exceeding of the threshold is based on an aggregate of all the parent nodes. In some aspects, an entry (e.g., parent node) having a high degree of leaf nodes may be selected and placed in the blacklist container. The selected entry may include anomalous data that is inconsistent with historical or expected data. For example, the selected entry (e.g., parent node) may indicate a high usage of resources that may be indicative of malicious behavior. In some aspects, the parent node having the highest count of leaf nodes than other parent nodes within the key space may be the selected entry.

At block 206, processing logic removes the corresponding parent node within the key space in response to the count of the one or more leaf nodes exceeding the threshold. Removal of the parent node places the parent node in the blacklist container, such that subsequent events that arrive for processing by the one or more leaf nodes associated with the parent node placed in the blacklist container are dropped and prevented from re-entering the system.

At 208, processing logic frees the resources utilized by removed leaf nodes for use for new leaf nodes within the key space. In addition to being placed in the blacklist container, an additional message is broadcast to remaining leaf nodes within the key space having instructions to reclaim resources dedicated to processing the by the one or more leaf nodes associated with the removed or offending parent node.

FIG. 3 is a block diagram 300 that illustrates an example of a computing system 302 for selective removal of leaf nodes within key spaces in accordance with some aspects of the present disclosure. In some aspects, the computing system 302 may perform some or all of the functionality described herein. The computing system 302 includes a processing device 304 (e.g., general purpose processor, a programmable logic device (PLD), etc.), which may be composed of one or more processors, and a memory 306. The memory 306 stores instructions 308 that are executed by the processing device 304. The instructions 308, when executed by the processing device 304, cause the processing device 304 to

The computing system 302 includes a processing device 304 (e.g., general purpose processor, a PLD, etc.), which may be composed of one or more processors, and a memory 306 (e.g., synchronous dynamic random-access memory (DRAM), read-only memory (ROM)), which may communicate with each other via a bus (not shown).

The processing device 304 may be provided by one or more general-purpose processing devices such as a microprocessor, central processing unit, or the like. In some embodiments, processing device 304 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 304 may include one or more special-purpose processing devices such as an application specific integrated circuit (ASIC), a field programmable gate array (FPGA), a digital signal processor (DSP), network processor, or the like. The processing device 304 may be configured to execute the operations described herein, in accordance with one or more aspects of the present disclosure, for performing the operations and steps discussed herein.

The memory 306 (e.g., Random Access Memory (RAM), Read-Only Memory (ROM), Non-volatile RAM (NVRAM), Flash Memory, hard disk storage, optical media, etc.) of processing device 304 stores data and/or computer instructions/code for facilitating at least some of the various processes described herein. The memory 306 includes tangible, non-transient volatile memory, or non-volatile memory. The memory 306 stores programming logic (e.g., instructions/code) that, when executed by the processing device 304, controls the operations of the computing system 302. In some embodiments, the processing device 304 and the memory 306 form various processing devices and/or circuits described with respect to computing system 302.

The processing device 304 executes a tracking component 310, an identification component 312, a removal component 314, and a capturing component 316. The tracking component 310 may track the count of one or more leaf nodes associated with a parent node within a key space. The stateful streaming model 320 may partition data in a tree structure with one or more layers, where each layer represents a key space or domain in the model. The identification component 312 may identify whether the count of the one or more leaf nodes exceeds a threshold. The removal component 314 may remove a parent node in response to the count of the one or more leaf nodes exceeding the threshold, such that the parent node is placed in a blacklist container. The capturing component 316 may capture the resources utilized by leaf nodes associated with the removed parent node for use by leaf nodes within the key space. The removal component 314 may determine to remove the parent node from the blacklist container and reintroduce the parent node and its associated leaf nodes within the key space. The statistical learning model 322 may be trained on data based at least on the usage of resources of the one or more leaf nodes within the key space.

FIG. 4 is a block diagram 400 that illustrates an example of a computing system 402 for selective removal of leaf nodes within key spaces in accordance with some aspects of the present disclosure. In some aspects, the computing system 402 may perform some or all of the functionality described herein. The computing system 402 includes a processing device 404 and memory 406. The memory 406 stores instructions 408 that are executed by the processing device 404. The instructions 408, when executed by the processing device 404, cause the processing device 404 to perform a methodology described herein.

In an example, the processing device 404 tracks a count 410 of leaf nodes 416 associated with a parent node 418 within a key space 412. The processing device 404 identifies whether the count 410 of the leaf nodes 416 exceeds a threshold 414. The processing device 404 removes the parent node 418 within the key space 412 in response to the count 410 of the leaf nodes 416 exceeding the threshold 414. The processing device 404 frees resources 422 utilized by the leaf node 416 removed from the key space 412 for use by other leaf nodes 420 within the key space 412.

In some aspects, to remove the parent node within the key space, the processing device may select the oldest parent node for removal from the key space. The threshold for removal is based on a total count of all leaf nodes in the system, such that when the threshold is exceeded, the oldest parent node may be selected for removal from a largest container, where the container is based on a size of parent nodes grouped together. For example, in instances where multiple parent nodes have a count that exceeds the threshold, the oldest parent node from the multiple parent nodes that have the count that exceeds the threshold may be selected for removal.

In some aspects, the processing device may place the parent node into a blacklist container, where subsequent events that arrive for processing by leaf nodes associated with the parent node in the blacklist container are dropped or discarded.

In some aspects, the processing device provides a broadcast message to the other leaf nodes within the key space where the broadcast message includes instructions for the other leaf nodes to reclaim resources dedicated to processing the leaf node associated with the removed parent node in response to the removal of the parent node from the key space.

In some aspects, to remove the parent node within the key space, the processing device may select the parent node having a highest count of leaf nodes within the key space. In some aspects, the parent node having the highest count of leaf nodes is selected for removal as having anomalous data that is inconsistent with historical or expected data. In some aspects, the parent node having the highest count of leaf nodes is selected for removal as being indicative of malicious behavior.

In some aspects, to remove the parent node within the key space, the processing device may select the parent node for removal that comprises data that is inconsistent with data of other parent nodes within the key space.

In some aspects, the processing device may reinstate the parent node into the key space based on an exit policy. In some aspects, the exit policy is based on a time duration, a HLL algorithm, or a cardinality estimation.

FIG. 5 illustrates a diagrammatic representation of a machine in the example form of a computer system 500 within which a set of instructions, for causing the machine to perform any one or more of the methodologies discussed herein for tracking a count of one or more leaf nodes within a key space.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 500 may be representative of a server.

The exemplary computer system 500 includes a processing device 502, a main memory 504 (e.g., read-only memory (ROM), flash memory, dynamic random access memory (DRAM), a static memory 505 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., an acoustic signal generation device, such as a speaker). In some embodiments, the video display unit 510, the alphanumeric input device 512, and the cursor control device 514 may be combined into a single component or device (e.g., an LCD touch screen).

The processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute selection instructions 525, for performing the operations and steps discussed herein.

The data storage device 518 may include a machine-readable storage medium 528 that stores the selection instructions 525 (e.g., software) embodying any one or more of the methodologies of functions described herein. The selection instructions 525 may also reside, completely or at least partially, within the main memory 504 or within the processing device 502 during execution thereof by the computer system 500; the main memory 504 and the processing device 502 also constituting machine-readable storage media. The selection instructions 525 may further be transmitted or received over a network 520 via the network interface device 508.

While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “tracking,” “identifying,” “removing,” “capturing,” “freeing,” “selecting,” “placing,” “providing,” “reinstating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
tracking a count of leaf nodes associated with a parent node within a key space;
identifying whether the count of the leaf nodes exceeds a threshold;
removing, by a processing device, the parent node within the key space in response to the count of the leaf nodes exceeding the threshold; and
freeing resources utilized by the leaf nodes removed from the key space for use by other leaf nodes within the key space.

2. The method of claim 1, wherein the removing the parent node within the key space further comprises:
selecting the parent node for removal from the key space.

3. The method of claim 2, further comprising:
placing the parent node into a blacklist container, wherein subsequent events that arrive for processing by the leaf nodes associated with the parent node in the blacklist container are dropped.

4. The method of claim 1, further comprising:
providing a broadcast message to remaining leaf nodes within the key space comprising instructions to reclaim resources dedicated to processing the leaf node in response to the removal of the parent node from the key space.

5. The method of claim 1, wherein the removing the parent node within the key space further comprises:
selecting the parent node having a highest count of leaf nodes than other parent nodes within the key space.

6. The method of claim 5, wherein the parent node having the highest count of leaf nodes is selected for removal as having anomalous data that is inconsistent with historical or expected data.

7. The method of claim 5, wherein the parent node having the highest count of leaf nodes is selected for removal as being indicative of malicious behavior.

8. The method of claim 1, wherein the removing the parent node within the key space further comprises:
selecting the parent node for removal that comprises data that is inconsistent with data of other parent nodes within the key space.

9. The method of claim 1, further comprising:
reinstating the parent node into the key space based on an exit policy.

10. The method of claim 9, wherein the exit policy is based on a time duration, a hyperloglog (HLL) algorithm, or a cardinality estimation.

11. A system, comprising:
a processing device; and
a memory to store instructions that, when executed by the processing device, cause the processing device to:
track a count of leaf nodes associated with a parent node within a key space;
identify whether the count of the leaf node exceeds a threshold;
remove the parent node within the key space in response to the count of the leaf nodes exceeding the threshold; and
free the resources utilized by the leaf node removed from the key space for use by other leaf nodes within the key space.

12. The system of claim 11, wherein to remove the parent node within the key space, the instructions cause the processing device to:
select the parent node for removal from the key space.

13. The system of claim 12, wherein the instructions cause the processing device to:
place the parent node into a blacklist container, wherein subsequent events that arrive for processing by the leaf nodes associated with the parent node are dropped.

14. The system of claim 11, wherein the instructions cause the processing device to:
provide a broadcast message to remaining leaf nodes within the key space comprising instructions to reclaim resources dedicated to processing the leaf node in response to the removal of the parent node from the key space.

15. The system of claim 11, wherein to remove the parent node within the key space, the instructions cause the processing device to:
select the parent node having a highest count of leaf nodes than other parent nodes within the key space.

16. The system of claim 11, wherein to remove the parent node within the key space, the instructions cause the processing device to:
select the parent node for removal that comprises data that is inconsistent with data of other parent nodes within the key space.

17. The system of claim 11, wherein the instructions cause the processing device to:
reinstate the parent node into the key space based on an exit policy.

18. A non-transitory computer readable medium, having instructions stored thereon which, when executed by a processing device, cause the processing device to:
track a count of leaf nodes associated with a parent node within a key space;
identify whether the count of the leaf node exceeds a threshold;
remove, by the processing device, the parent node within the key space in response to the count of the leaf nodes exceeding the threshold; and
free the resources utilized by the leaf node removed from the key space for use by other leaf nodes within the key space.

19. The non-transitory computer readable medium of claim 18, wherein to remove the parent node within the key space, the instructions cause the processing device to:
select the parent node for removal from the key space.

20. The non-transitory computer readable medium of claim 19, wherein the instructions cause the processing device to:
place the parent node into a blacklist container, wherein subsequent events that arrive for processing by the leaf nodes associated with the parent node are dropped.
